(19) United States
(12) Patent Application Publication
(10) Pub. No.: US 2016/0267120 A1
(43) Pub. Date: Sep. 15, 2016

(54) SYSTEM AND METHOD FOR POLYMORPHING CONTENT ITEMS

(71) Applicant: IM Creator Ltd., New York, NY (US)

(72) Inventors: Jonathan SARAGOSSI, Tel Aviv (IL); Gilad NAVOT, Tel Aviv (IL); Boaz SARAGOSSI, Tel Aviv (IL)

(73) Assignee: IM Creator Ltd., New York (NY)

(21) Appl. No.: 15/163,054

(22) Filed: May 24, 2016

Related U.S. Application Data
(63) Continuation of application No. PCT/US2015/051313, filed on Sep. 22, 2015.
(60) Provisional application No. 62/053,813, filed on Sep. 23, 2014.

(51) Int. Cl. G06F 17/30

(52) U.S. Cl. CPC G06F 17/30345; G06F 17/30893

(57) ABSTRACT

A system and method for polymorphing content items. The method comprises: dividing a content item into a plurality of content fragments based on at least one index value, each content fragment having at least one data type; and generating at least one polymorph respective of the plurality of content fragments, wherein each polymorph is compatible with each data type of at least two of the content fragments.

### CROSS-REFERENCE TO RELATED APPLICATIONS

This application a continuation of U.S. Application No. PCT/US2015/051313 filed on Sep. 22, 2015 which claims the benefit of U.S. Provisional Application No. 62/053,813 filed on Sep. 23, 2014, the contents of which are hereby incorporated by reference.

### TECHNICAL FIELD

The present disclosure relates generally to analyzing web-based content, and more particularly to polymorphing web-accessible content.

### BACKGROUND

In the field of computer science, polymorphism may be utilized to handle different types of data items. Ad hoc polymorphism is the provision of a single interface to entities of different types. Such provision may involve providing functions that can be applied to arguments of different types. When a polymorphic function is applied, different types of arguments may yield different results. Parametric polymorphism, in contrast to ad hoc polymorphism, involves providing functions that can be applied to arguments of different types to yield uniform results. Parametric polymorphism functions are configured to process data of any type and to yield appropriate results respective thereof.

Conventional methods for utilizing polymorphism require predetermined functions configured to handle the various types of data that may be received. A significant drawback of such conventional methods is that, if a predetermined function is not preconfigured to handle a particular type of data, data of that type will not be accepted. In particular, this may be an issue when attempting to access data of various types, such as data accessible through the web. If the various types of data are not utilized by subclasses of the same base class, attempting to unify them via polymorphism may prove challenging.

It would therefore be advantageous to provide an efficient solution for generating polymorphs of data and, in particular, of data for web accessible content.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” may be used herein to refer to a single embodiment or multiple embodiments of the disclosure.

The disclosed embodiments include a method for polymorphing content items. The method comprises: dividing a content item into a plurality of content fragments based on at least one index value, each content fragment having at least one data type; and generating at least one polymorph respective of the plurality of content fragments, wherein each polymorph is compatible with each data type of at least two of the content fragments.

The disclosed embodiments also include a system for polymorphing content items. The system comprises: a processing unit; and a memory, the memory containing instructions that, when executed by the processing unit, configure the system to: divide a content item into a plurality of content fragments based on at least one index value, each content fragment having at least one data type; and generate at least one polymorph respective of the plurality of content fragments, wherein each polymorph is compatible with each data type of at least two of the content fragments.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe the various disclosed embodiments;

FIG. 2 is a schematic diagram of a system for generating polymorphs respective of web-accessible content items according to an embodiment;

FIG. 3 is a diagram illustrating polymorph generation based on content items according to an embodiment;

FIG. 4 is a flowchart illustrating a method for generating content fragments based on content items according to an embodiment; and

FIG. 5 is a flowchart illustrating a method for generating polymorphs of content fragments according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various exemplary and non-limiting embodiments allow for generating polymorphs based on content items, each such content item may have various data types. At least one content item is received or mined from at least one data source. Metadata is identified respective of the content item. A plurality of index values is extracted from a database. Each content item is divided into content fragments based on the index values. Polymorphs are generated based on the content fragments and the metadata.

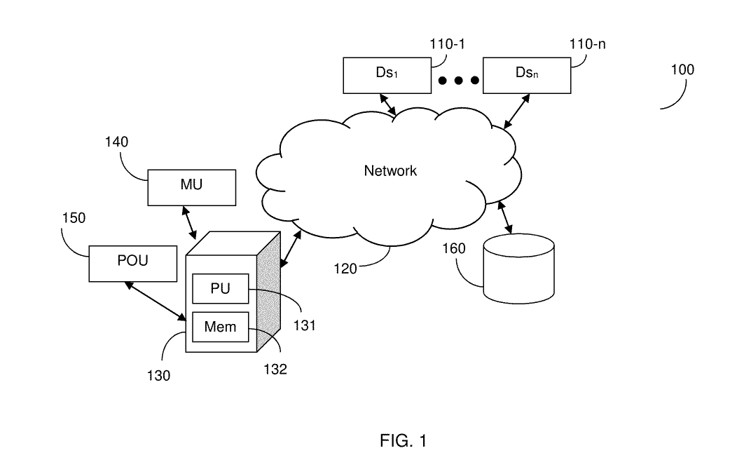

FIG. 1 depicts an exemplary and non-limiting network diagram 100 utilized to describing the various disclosed embodiments. A plurality of data sources (DSs) 110-1 through 110-n (hereinafter referred to collectively as data sources 110 or individually as a data source 110, merely for simplicity purposes) are connected to a network 120. The data sources 110 may be, but are not limited to web sources, web-pages, private cloud sources, public cloud sources, social networks, storage units of user devices, and the like. The network 120 may be, but is not limited to, a local area network (LAN), a wide area network (WAN), a metro area network (MAN), the world wide web (WWW), the Internet, a wired network, a wireless network, and the like, as well as any combination thereof.

The network 120 is further communicatively connected to a server 130. The server 130 is configured to access the data sources 110 and to retrieve content items stored therein. The retrieval of content items from the data source 110 may be through a mining process. Specifically, in an embodiment, the mining process is performed using a mining unit (MU) 140.

The mining unit 140 may be communicatively connected and external to the server 130 or integrated in the server 130. In an embodiment, the mining process includes crawling through the data sources 110 and identifying at least one content item existing therein. The mining further includes identifying metadata respective of the at least one content item. Thereafter, the server 130 is configured to retrieve or extract the identified content item or items and the respective metadata for further processing. A content item may include, but is not limited to, a textual item, a graphical item, and/or a combination thereof. A graphical item may be, for example, a multimedia content item such as an image, a graphic, a video stream, a video clip, a video frame, a photograph, and so on

Alternatively, the server 130 is configured to receive content items from other devices and/or data sources including, but not limited to, user devices (not shown) communicatively connected to the network 120. Each user device may be, but is not limited to, a smart phone, a mobile phone, a laptop, a tablet computer, a personal computer (PC), a wearable computing device, a smart television, and so on.

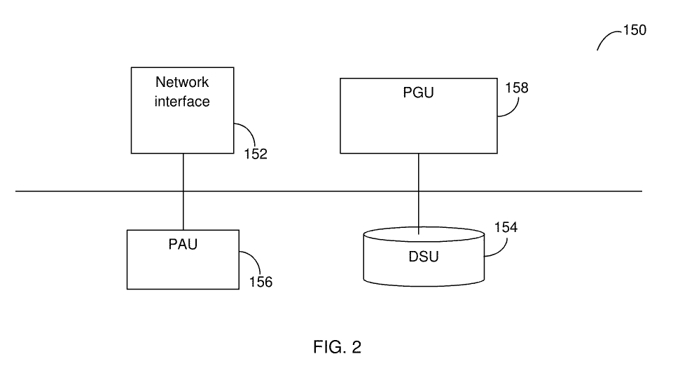

A plurality of index values are obtained by the server 130 from, for example, a database (DB) 160 accessible over the network 120. Alternatively, a polymorphism unit (POU) 150 communicatively connected to the server may store the plurality of index values therein as further described herein below with respect of FIG. 2. Each index value represents a unitary fragment index assigned to at least a portion of a content item. The index values enable the classification, dividing, and parsing of a content items into content fragments. The content fragments may include, but are not limited to, an image, a video, a title, a sub-title, a date, a text-body, a link to content, a price, or any piece of information in the content item, a combination thereof, and a portion thereof. Each index value may include a set of metadata associated thereto that assists with the division. The metadata comprises identifiers indicative of the association or clustering between portions of the content items.

Respective of the index values, the server 130 or the POU 150 are configured to divide each one of the content items into a plurality of content fragments. Each content fragment can be responsive, adaptive, and customized. The division of the content items may include parsing of each of the content items. The parsing may yield hierarchical structures, each hierarchical structure representing a structure of a content item. In an embodiment, the plurality of content fragments is sent for storage in, for example, the database 160. The POU 150 is described further herein below with respect to FIG. 2.

The server 130 or the POU 150 can generate at least one polymorph respective of the plurality of content fragments and the identified metadata. It should be noted that each polymorph is a newly generated collection of data which is unified and generic in a manner that enables unitary interactions. Each polymorph at least includes one or more content fragments, and may be adapted for each new content fragment introduced. In an embodiment, additional polymorphs may be added to a polymorph via, e.g., clustering. The generation of the polymorphs respective of content fragments enables the implementation of the polymorphs in various ways in a plurality of platforms.

According to one embodiment, the polymorph is generated such that it is compatible with each data type associated with at least two of the plurality of content fragments. A polymorph is compatible with a data type if it is accepted by functions that can properly utilize that data type.

In an embodiment, the at least one polymorph is sent for storage in, for example, the database 160. It should be noted that even though the MU140 and the POU 150 are described as separated units merely for simplicity purposes, either or both of them may be included in the server 130 without departing from the scope of the disclosed embodiments.

In an embodiment, the server 130 may include a processing unit 131 coupled to a memory 132, the memory containing instructions that, when executed by the processing unit 131, configures the server to perform the disclosed embodiments.

Specifically, each, some, or all of the processing unit 131, mining unit 140, and polymorphism unit 150 may be realized by a processing system. The processing system may comprise or be a component of a larger processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

FIG. 2 depicts an exemplary and non-limiting schematic diagram of the POU 150 according to an embodiment. It should be noted that, in an embodiment, the POU 150 may comprise or be a component of a system containing a processor and a memory, the memory containing instructions for configuring the POU 150 to perform the disclosed embodiments. The POU 150 includes a network interface 152 through which the POU 150 can communicate with the server 130, the data sources 110, and/or one or more user devices over the network 120. The POU 150 can also receive content items and respective metadata through the network interface 152.

The POU 150 further includes a data storage unit (DSU) 154. The DSU 154 stores a plurality of index values, wherein each index value represents a unitary fragment index. The POU 150 also includes a parsing unit (PAU) 156. The PAU 156 is configured to divide and/or parse at least one content item received through the network interface 152. The parsing is performed respective of the plurality of index values stored in the DSU 154. In an embodiment, the parsing is performed further respective of the metadata associated with the index values. The metadata includes identifiers indicative of the association or clustering between portions of the content items. The parsing may yield a hierarchical structure representing the structure of the content item, wherein the associations in the hierarchy may be based on the metadata.

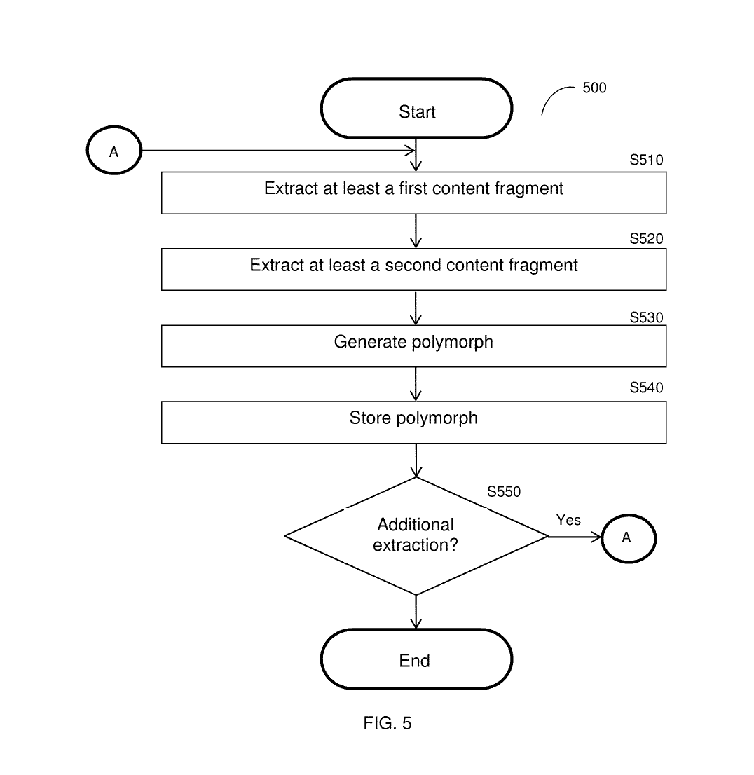

The POU 150 additionally includes a polymorphism generation unit (PGU) 158. The PGU 158 is configured to generate unified and generic polymorphisms respective of the content fragments and their respective metadata as described further herein below with respect to FIG. 5.

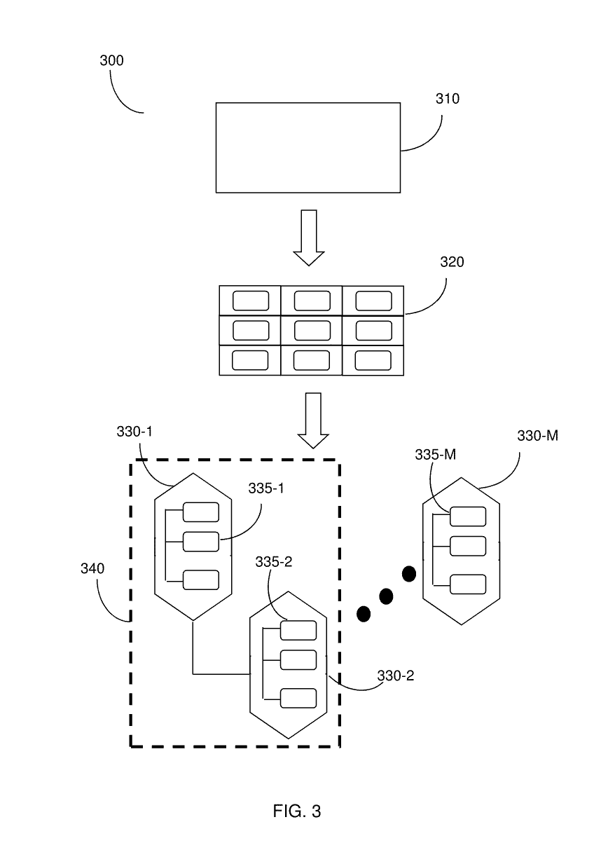

FIG. 3 depicts an exemplary and non-limiting flow diagram 300 illustrating the flow of data when generating polymorphs from a content item according to an embodiment. A content item 310 is received. In an embodiment, the content item may be received through a network interface (e.g., the network interface 152). The content item 310 is parsed into a plurality of content fragments 320 respective of a plurality of index values. It should be noted that the parsing may be repeated until a plurality of content fragments 330-1 through 330-M are generated.

Multiple polymorphs 330-1 through 330-M (M is an integer greater than 1) are generated from the plurality of content fragments 320. Each polymorph 330 includes one or more content fragments. Each polymorph 330 is generated such that the polymorph is compatible with each data type associated with at least two of the plurality of content fragments and is adapted based on each of the content fragments 320.

In an embodiment, generation of polymorphs may include clustering any of the polymorphs 330-1 through 330-M. In the embodiment shown in FIG. 3, the polymorphs 330-1 and 330-2 are clustered into a cluster 340. Clustering of the polymorphs allows for any associations and/or clusters between the content fragments to be preserved during polymorphing, thereby ensuring that the polymorph for each content fragment is associated with the polymorphs of related content fragments.

It should be noted that the parsing and polymorphing described with respect to FIG. 3 enables generation of polymorphic structures respective of content items, thereby allowing generic interaction with each content item respective thereof. For example, interaction with a content item divided into polymorphed content fragments may be unitary regardless of the initial data type of each content fragment.

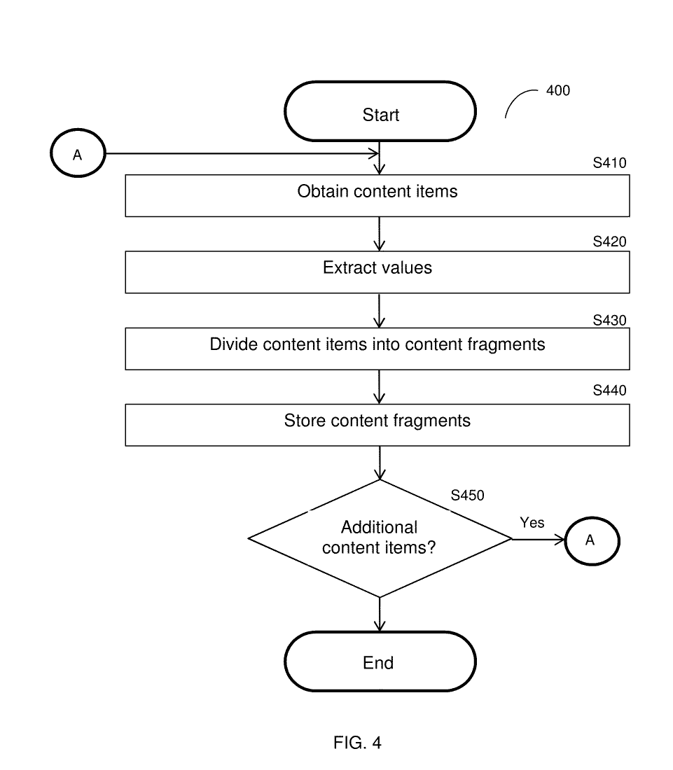

FIG. 4 depicts an exemplary and non-limiting flowchart 400 of a method for generating content fragments respective of content items according to an embodiment. In S410, a content item is obtained from at least one data source (e.g., the data sources 110). The content items may be obtained by, e.g., being received, being mined, and so on. In an embodiment, a mining process includes identification and extraction of at least a portion of the at least one content item stored in the at least one data source. In an embodiment, the mining may be performed using a mining unit (e.g., the MU 140).

In S420, a plurality of index values is extracted. As noted above, each index value represents a unitary fragment index assigned to a portion of a content item. The index values may be extracted from a database (e.g., the database 160). In S430, respective of the extracted index values, the at least one content item is divided into one or more content fragments. The division of the content item may include parsing of the content item and is described further herein above with respect to FIGS. 1-3. In S440, the content fragments are stored, for example, the database. In S450, it is checked whether additional content items should be obtained and, if so, execution continues with S410; otherwise, execution terminates.

FIG. 5 is an exemplary and non-limiting flowchart 500 illustrating a method for polymorphing content fragments according to one embodiment. In S510, a first content fragment of a content item is obtained. In an embodiment, the first content fragment may be obtained from a database (e.g., the database 160). In another embodiment, S510 may begin with receiving a request from a user device to polymorph content fragments. In a further embodiment, the request may include content fragments.

In S520, a second content fragment of the content item is obtained. The second content fragment may be obtained from, e.g., the database containing the first fragment and/or the content item. It should be noted that each of the first and second content fragments may include multiple content fragments of a specific content item. It should further be noted that each content fragment may be an isolated content fragment, or may be a content fragment included in a previously generated polymorph.

In S530, at least one polymorph is generated respective of the at least a first content fragment and the at least a second content fragment. Each polymorph includes one or more content fragments as well as data that may be utilized with functions that utilize different data types. To this end, each polymorph includes at least one portion of data belonging to each required data type. The data types of the polymorphs are adapted based on the data type of the at least a first content fragment and of the at least a second content fragment.

Specifically, according to one embodiment, at least one polymorph may be generated such that each polymorph is compatible with functions utilizing each data type of the at least a first fragment and of the at least a second content fragment. To this end, it may be determined which data type(s) are associated with each of the at least a first content fragment and the at least a second content fragment. As a non-limiting example, if a content item is divided into a first content fragment including data of type String and a second content fragment of type Boolean, a polymorph may be generated which is compatible with both String and Boolean functions.

In an embodiment, generating a polymorph may include any of: generating a new polymorph based on two content fragments, or adding to an existing polymorph based on a newly obtained content fragment. Accordingly, polymorphs may be cumulatively generated based on each content fragment within the content item.

In S540, the generated polymorph is stored. In S550, it is checked whether additional content fragments should be obtained and, if so, execution continues with S510; otherwise, execution terminates. In an embodiment, additional content fragments are extracted until a polymorph is generated respective of each content fragment, wherein each polymorph is compatible with all data types associated with the content fragments.

It should be noted that the method for generating content fragments as described herein above with respect to FIG. 4 and the method for polymorphing content fragments as described herein below with respect to FIG. 5 may be integrated without departing from the scope of the disclosed embodiments.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for polymorphing content items, comprising:
dividing a content item into a plurality of content fragments based on at least one index value, each content fragment having at least one data type; and
generating at least one polymorph respective of the plurality of content fragments, wherein each polymorph is compatible with each data type of at least two of the content fragments.

2. The method of claim 1, wherein dividing a content item into at least one content fragment further comprises:
parsing the content item into at least one content fragment organized in a hierarchical structure representative of the content item.

3. The method of claim 2, wherein generating at least one polymorph further comprises:
clustering any of the at least one polymorph.

4. The method of claim 1, wherein each index value represents a unitary fragment index of a portion of the content item and includes metadata indicating associations or clusters between portions of the content item.

5. The method of claim 1, further comprising:
mining the content item from a data source.

6. The method of claim 1, wherein generating at least one polymorph further comprises:
obtaining at least a first content fragment and at least a second content fragment of the content item; and
determining each data type of the at least a first content fragment and the at least a second content fragment, wherein the at least one polymorph is compatible with each determined data type.

7. The method of claim 1, wherein each content fragment is any of: an image, a video, a title, a sub-title, a date, a text-body, a link to content, and a price.

8. A non-transitory computer readable medium having stored thereon instructions for causing one or more processing units to execute the method according to claim 1.

9. A system for polymorphing content items, comprising:
a processing unit; and
a memory, the memory containing instructions that, when executed by the processing unit, configure the system to:
divide a content item into a plurality of content fragments based on at least one index value, each content fragment having at least one data type; and
generate at least one polymorph respective of the plurality of content fragments, wherein each polymorph is compatible with each data type of at least two of the content fragments.

10. The system of claim 9, wherein the system is further configured to:
parse the content item into at least one content fragment organized in a hierarchical structure representative of the content item.

11. The system of claim 10, wherein the system is further configured to:
cluster any of the at least one polymorph.

12. The system of claim 9, wherein each index value wherein each index value represents a unitary fragment index of a portion of the content item and includes metadata indicating associations or clusters between portions of the content item.

13. The system of claim 9, wherein the system is further configured to:
mine the content item from a data source.

14. The system of claim 9, wherein the system is further configured to:
extract at least a first content fragment and at least a second content fragment of the content item; and
determine each data type of the at least a first content fragment and the at least a second content fragment, wherein the at least one polymorph is compatible with each determined data type.

15. The system of claim 9, wherein each content fragment is any of: an image, a video, a title, a sub-title, a date, a text-body, a link to content, and a price.
